(19) United States
(12) Patent Application Publication
(10) Pub. No.: US 2021/0324991 A1
(43) Pub. Date: Oct. 21, 2021

(54) INSPECTION METHOD AND INSPECTION VEHICLE

(71) Applicant: Siemens Energy Global GmbH & Co. KG, Munich, Bayern (DE)

(72) Inventors: Rayk Lagodka, Falkensee (DE); Benjamin Runge, Berlin (DE)

(73) Assignee: Siemens Energy Global GmbH & Co. KG, Munich, Bayern (DE)

(21) Appl. No.: 17/270,018

(22) PCT Filed: Jul. 9, 2019
(86) PCT No.: PCT/EP2019/068372

§ 371 Date: Feb. 21, 2021

(30) Foreign Application Priority Data
Aug. 27, 2018 (DE) 10 2018 214 413.3

(51) Int. Cl. F16L 55/32; B62D 61/10; B62D 61/12; G01N 21/954

(52) U.S. Cl. CPC F16L 55/32; B62D 61/10; F16L 2101/30; G01N 21/954; B62D 61/12

(57) ABSTRACT

A method for inspecting the interior of an annular cavity, in particular an annular combustion chamber of a gas turbine of a power station, which combustion chamber has an asymmetric cross-section, the method being carried out using an inspection vehicle. An inspection vehicle is adapted for carrying out the method.

### CROSS REFERENCE TO RELATED APPLICATIONS

This application is the US National Stage of International Application No. PCT/EP2019/068372 filed 9 Jul. 2019, and claims the benefit thereof. The International Application claims the benefit of German Application No. DE 10 2018 214 413.3 filed 27 Aug. 2018. All of the applications are incorporated by reference herein in their entirety.

### FIELD OF INVENTION

The invention concerns a method for inspecting the interior of an annular cavity, in particular in the form of an annular combustion chamber, with an asymmetric cross-section, of a gas turbine of a power station. The invention furthermore concerns an inspection vehicle for performing such a method.

### BACKGROUND OF INVENTION

Annular combustion chambers of gas turbines require regular inspection in order for example to determine the state of the heat shield plates which line the annular combustion chamber as protection from the high temperatures. In the context of such an inspection, an inspector must enter the annular combustion chamber in order to mark and measure any damage by hand. Then based on the findings, a decision is made on whether or not to replace the components concerned. Furthermore, a record is made and in some cases the findings are transmitted to a database.

However, in order to allow access by an inspector to the annular combustion chamber, it is necessary to reduce the temperature inside the annular combustion chamber to at most 40° C. and suspend the rotary operation of the rotor. This leads to substantial downtimes and high costs. A further disadvantage of the above-described inspection is that the findings depend very individually on the inspector concerned. Despite corresponding qualification, these always have a subjective nature.

### SUMMARY OF INVENTION

Starting from this prior art, it is an object of the present invention to create a method of the type cited initially which at least partially eliminates the above-described disadvantages.

To achieve this object, the present invention provides a method of the type cited initially which is characterized in that it is performed using an inspection vehicle. The use of such an inspection vehicle is advantageous in that no person need enter the annular combustion chamber. In this context, in order to perform the method, it is also not necessary to lower the temperature inside the annular combustion chamber to 40° C., which takes a very long time. Rather, the inspection may already begin at higher temperatures, which is associated with shorter downtimes. Because the inspection vehicle autonomously travels through the combustion chamber and performs the inspection, a highly objective finding is achieved with constant quality standard. Furthermore, no manual recording of inspection results is required, with no errors in transmitting manually recorded notes to a database.

Also, to achieve the object cited initially, the present invention provides an inspection vehicle which is configured to perform the method according to the invention. The inspection vehicle comprises a chassis; two wheel groups which are held on the chassis and which are configured to move the inspection vehicle through the cavity in a circumferential direction, and each of which comprises at least four wheels, wherein the wheels of the first wheel group are configured to rest on a radially outwardly arranged cavity wall, and wherein the wheels of the second wheel group are configured to rest on a radially inwardly arranged cavity wall; several motors which are assigned to the different wheels and drive these by motor in rotation about their respective wheel axles; a control device actuating the motors; and an inspection device held on the chassis. Thanks to the two wheel groups, the wheels of which protrude on one side downwards and on the other side upwards from the chassis, the inspection vehicle according to the invention rests securely on the radially inwardly arranged cavity wall and on the radially outwardly arranged cavity wall, whereby the inspection vehicle can easily travel over the 360° extent of the annular combustion chamber autonomously by means of the motorized drive. The motors are advantageously assigned to at least two wheels of the first wheel group lying opposite each other with respect to the chassis, and two wheels of the second wheel group lying opposite each other, in order to guarantee a proper advance of the inspection vehicle at all positions of the annular cavity. Naturally, also all wheels of the inspection vehicle may be driven by a respective motor. During travel through the annular cavity, the inspection takes place using the inspection device, for example by acquiring corresponding image data. The cavity positions at which the image data are acquired by the inspection device may be calculated, for example, by determining the distance covered by the inspection vehicle starting from the starting point of the inspection. To determine the distance, the number of revolutions of the individual motors may be used. Alternatively or additionally, a distance sensor may be provided on the chassis or arranged separately in order to detect the distance covered.

According to an embodiment of the present invention, two respective wheels of a wheel group are arranged opposite each other in pairs with respect to the chassis, as usual in conventional vehicles. This leads to a simple structure of the inspection vehicle according to the invention.

Advantageously, none of the wheel axles extends parallel to another wheel axle. In other words, the orientation of each individual wheel is adapted to the asymmetric cross-section of the annular cavity, which ensures a particularly secure holding of the inspection vehicle during its passage through the cavity.

Advantageously, the respective distances between the wheel axles of the wheels of at least one of the wheel groups and the chassis are individually changeable, in particular adjustable via pneumatically or electrically operated telescopic devices which can be retracted and extended linearly. In the retracted state of the telescopic devices, the inspection vehicle can thus be positioned easily in the cavity to be inspected. In addition, the distances may be increased, in particular by extension of the telescopic devices, such that all wheels bear on the assigned cavity wall with a corresponding contact pressure.

According to one embodiment of the present invention, each motor is connected to a wheel via at least one gear mechanism which serves to adapt the rotation speed. Also advantageously, a worm gear mechanism is connected to the drive wheel. The worm gear mechanism, because of the self-locking, allows blocking of the wheels even on failure of the power supply, so that on failure of the power supply, the inspection vehicle is securely locked in its position inside the cavity.

The inspection vehicle is advantageously supplied with power and/or data and/or compressed air via at least one supply line. In this case, advantageously a winding device is provided for automatically unwinding and winding the at least one supply line, in order to avoid crossing over the supply line and undesirable tension forces due to trailing loops of the at least one supply line.

According to one embodiment of the present invention, distance sensors are arranged on the chassis, and are configured and arranged such that they detect actual distances from a side wall of the annular cavity, wherein the control device is configured such that it compares the actual distances with nominal distances obtained from CAD data of the cavity, and actuates the motors on the basis of the comparison result. The distance sensors, oriented substantially in the axial direction of the annular cavity, may for example be distributed over the length of the inspection vehicle, in order to determine the precise orientation of the inspection vehicle inside the cavity by corresponding comparison of the detected distance data. If the actual orientation does not correspond to the nominal orientation, individual motors may be actuated accordingly by the control device in order to correct the orientation.

Advantageously, at least one camera device connected to the control device is held on the chassis and oriented substantially in the axial direction of the annular cavity. In the case of an annular combustion chamber of a gas turbine, advantageously two camera devices are provided, one of which is oriented in the direction of the burners of the gas turbine and one in the direction of the turbine, so that the burners and the first guide vanes can also be inspected during passage through the annular combustion chamber.

The inspection device itself may be or become equipped with different sensors. To inspect an annular combustion chamber, said device advantageously comprises at least one camera device which is advantageously configured so that it can detect a complete heat shield plate in each case.

The inspection device is advantageously held on the chassis so as to be movable by motor relative to the chassis, so that it is as freely movable as possible inside the annular combustion chamber and can reach all regions to be inspected. Advantageously, the inspection device may be moved linearly along a linear axis extending substantially in the axial direction of the annular combustion chamber, pivoting about a first pivot axis extending substantially in the circumferential direction of the annular combustion chamber, pivoting about a second pivot axis extending parallel to the first pivot axis, and pivoting about a third pivot axis extending perpendicularly to the second pivot axis. In this way, an excellent freedom of movement of the inspection device is achieved with a simple structure.

### BRIEF DESCRIPTION OF THE DRAWINGS

Further features and advantages of the present invention are presented in the following description of an inspection vehicle according to one embodiment of the present invention, with reference to the attached drawing. The drawings show:

FIG. 1 a perspective view of an inspection vehicle according to one embodiment of the present invention;

FIG. 2 a further perspective view of the inspection vehicle shown in FIG. 1, wherein a winding device has been omitted for illustrative purposes;

FIG. 3 a perspective view of the inspection vehicle shown in FIG. 2 when travelling through an annular cavity; and

FIG. 4 a top view of the inspection vehicle shown in FIG. 2 when travelling through the annular cavity.

### DETAILED DESCRIPTION OF INVENTION

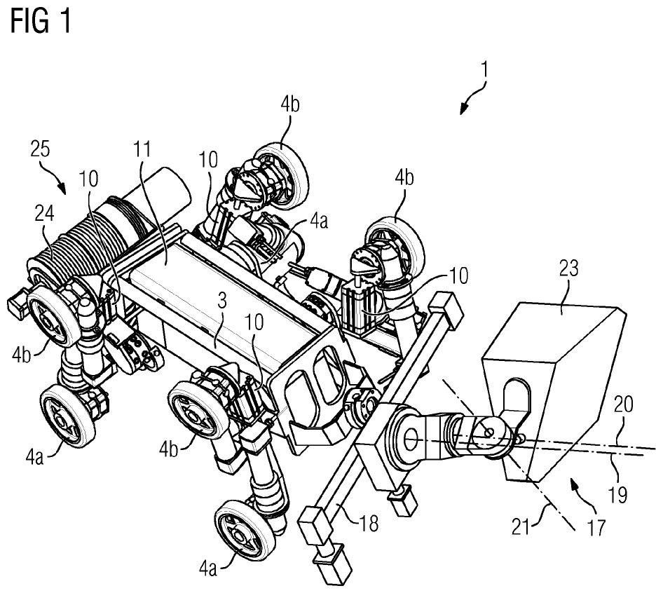

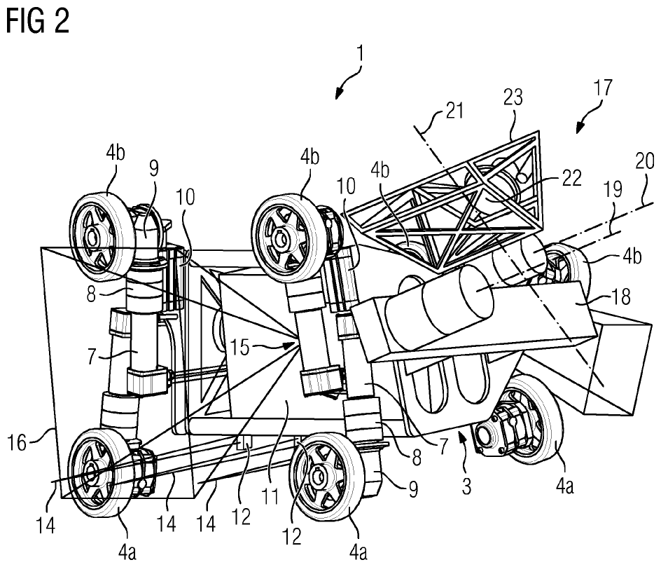

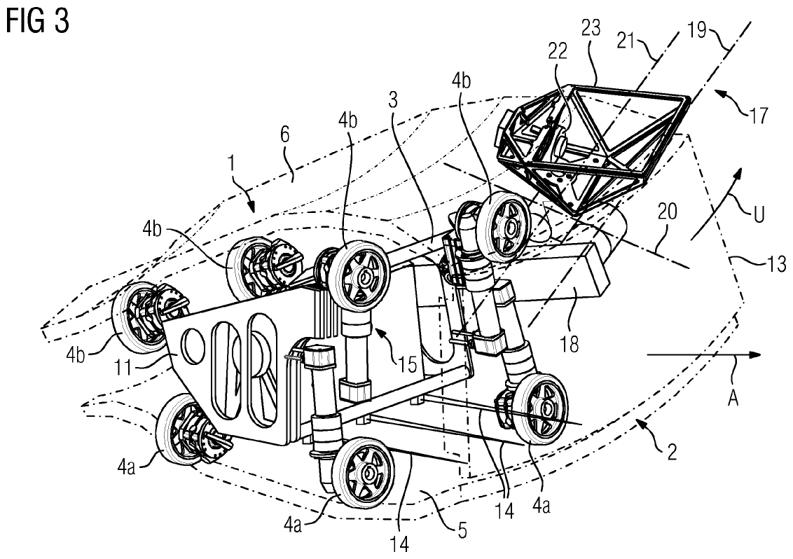

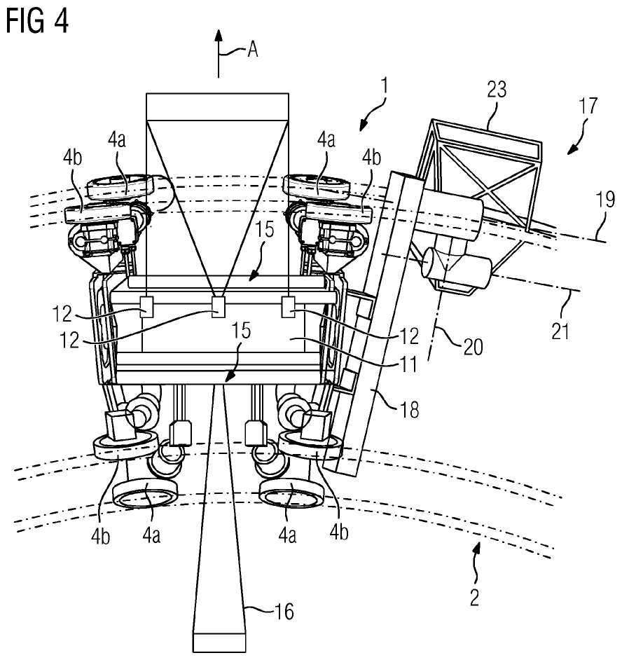

The inspection vehicle 1 shown in FIGS. 1 to 4 serves to inspect the interior of an annular cavity 2, in the present case an annular combustion chamber, with an asymmetric cross-section, of a gas turbine (not shown in more detail) of a power station. The inspection vehicle 1 comprises a chassis 3 which, in the embodiment illustrated, has a frame-like structure. Two wheel groups are held on the chassis 3 and are configured to move the inspection vehicle 1 through the cavity 2 in a circumferential direction U. The lower first wheel group shown in FIG. 1 has four wheels 4a which are configured to rest on a radially outwardly arranged cavity wall 5. The upper second wheel group shown in FIG. 1 also has four wheels 4b which are configured to rest on a radially inwardly arranged cavity wall 6. Here, two respective wheels of a wheel group are arranged opposite each other in pairs with respect to the chassis 3. In the present embodiment, an electric motor 7 is assigned to each wheel 4a, 4b and is connected to the associated wheel 4a, 4b via a first gear mechanism 8 and a second gear mechanism 9, which is a worm gear mechanism. Also, linearly retractable and extendable telescopic devices 10 are assigned to the wheels 4b of the upper second wheel group, so that the respective distances between the wheel axles of the wheels 4a, 4b and the chassis 3 can be adjusted or changed individually. The telescopic devices 10 are driven pneumatically in the present case. In principle however, it is also possible to provide these with electric motors. The wheel axles about which the wheels 4a, 4b rotate are each oriented differently, so that none of the wheel axles extends parallel to one of the other wheel axles. The motors 7 are actuated via a control device 11 which is also held on the chassis 3. Furthermore, distance sensors 12 are provided which are configured and arranged so as to detect actual distances of the chassis 3 from a side wall 13 of the annular cavity 2, as indicated by the lines 14, wherein the control device 11 is configured to compare the actual distances with nominal distances obtained from CAD data of the cavity 2, and to actuate the motors 7 on the basis of the comparison result. In the present case, three distance sensors 12 are provided which are held on the chassis 3, evenly spaced in the movement direction of the inspection vehicle 1 and substantially oriented in an axial direction A of the annular cavity 2. Furthermore, in the present case, two camera devices 15 connected to the control device 11 are held on the chassis 3 and also oriented substantially in the axial direction A of the cavity 2, such that one of the camera devices 15 detects the burners and the other camera device 15 detects the first guide vanes of the turbine, as indicated by lines 16 in the figures. In the present case, an inspection device 17 is arranged in the front region of the inspection vehicle 1 such that it can be moved by motor relative to the chassis 3, linearly along a linear axis 18 extending substantially in the axial direction of the annular combustion chamber 2, pivoting about a first pivot axis 19 extending substantially in the circumferential direction of the annular combustion chamber 2, pivoting about a second pivot axis 20 extending parallel to the first pivot axis 19, and pivoting about a third pivot axis 21 extending perpendicularly to the second pivot axis 20. In the present case, the linear movement along the linear axis 18 is implemented via a motor and a belt drive. The pivot movements are each implemented via a motor and an assigned gear mechanism. The inspection device 17 itself comprises a camera device 22 and a camera housing 23 which surrounds and protects this. The camera device 22 is configured such that in each case it can completely detect one of the heat shield elements lining the cavity 2. The inspection vehicle 1 is supplied with power, data and compressed air via at least one supply line 24 arranged on a winding device 25 which automatically unwinds and winds up the at least one supply line 24.

To perform an inspection of the annular cavity 2 or annular combustion chamber, in a first step, the inspection vehicle 1 is inserted into the cavity 2 through a manhole, wherein all of the telescopic devices 10 are in the retracted state. Then the telescopic devices 10 are extended until all wheels 4a, 4b bear with a contact pressure on the radially outwardly and inwardly arranged cavity walls 5 and 6. The orientation of the wheel axles is selected such that the orientation of the respective wheels 4a, 4b is optimally adapted to the asymmetric cross-section of the cavity 2. The orientation of the individual wheel axles may be fixedly preset. It may also be variable within certain limits, so that the inspection vehicle 1 can be adapted to different cross-sectional geometries of cavities 2. To facilitate insertion into the annular cavity 2, the inspection vehicle 1 may also have a modular structure. Accordingly, the modules may be inserted in the cavity 2 successively and only then connected together. Thus for example, it is conceivable to provide the chassis 3 with the control device 11, the wheels 4a, 4b arranged on the chassis 3 with the associated motors 7, gear mechanisms 8, 9 and telescopic devices 10, and the inspection device 17 with the linear axis and three pivot axes 19, 20, 21, as respective individual modules. The modular division of the inspection vehicle 1 may in principle be freely selected. The orientation of the linear axis 18 of the inspection device 17 should be selected such that the inspection device 17 can move as flexibly as possible in the axial direction A of the annular cavity 2. Here too, the design of the linear axis 18 or its fixing to the chassis 3 may be configured such that the extent of the linear axis can be adjusted in certain regions.

At the start of the inspection, a predefined starting point inside the cavity 2 is selected. The actual position of the inspection vehicle 1 is stored in the control device 11 and compared with CAD data of the cavity 2. Now the inspection vehicle 1 is moved through the cavity 2 in the circumferential direction U such that the inspection device 17 can detect each of the heat shield elements lining the cavity 2. Via the distance sensors 12, it can be established when the inspection vehicle 1 passes the transition between two adjacent heat shield elements. The respective position can then be compared with the CAD data of the cavity 2 in order to verify the actual position of the inspection vehicle 1 inside the cavity 2, which was calculated for example based on the number of revolutions of the individual motors 7. Thus it is ensured that the data detected by the inspection device 17 are assigned to the respective correct circumferential position of the cavity 2.

The distance sensors 12 detect the actual distances of the chassis 3 from the side wall 13 of the cavity 2 in the front, middle and rear region of the chassis 3. By comparing the data obtained from the three distance sensors 12 with nominal distances obtained from the CAD data of the cavity 2, it can be established whether the chassis 3 is correctly oriented relative to the side wall 13 of the cavity 2. If not, the control device 11 actuates one or more of the motors 7 driving the wheels 4a, 4b in order to correct the orientation of the chassis 3 relative to the side wall 13. In this way, the inspection vehicle 1 can be prevented from jamming inside the cavity 2.

During the movement of the inspection vehicle 1 through the cavity 2, the winding device 25 unwinds the supply line 24 as required. In this way, crossing over the supply line 24 and undesirable tension forces due to trailing loops of the supply line 24 can be avoided.

In the case of a power failure, the second gear mechanism 9 configured as a worm gear mechanism, because of its self-locking, ensures a blocking of the wheels 4a, 4b so that the inspection vehicle 1 is securely locked in its position inside the cavity 2.

The performance of an annular combustion chamber inspection using the inspection vehicle 1 according to the invention is advantageous in that no person need enter the annular cavity 2. Accordingly, the requirements imposed on the temperature of the annular combustion chamber and operation of the turbine for performance of an inspection are comparatively low. Because the inspection vehicle 1 autonomously travels through the cavity 2 and performs the inspection, a highly objective finding is achieved with constant quality standard. Furthermore, no manual recording of inspection results is required, with no errors in transmitting manually recorded notes to a database.

Although the invention has been illustrated and described in detail with reference to the exemplary embodiment, the invention is not restricted by the examples disclosed and other variants may be derived therefrom by the person skilled in the art without leaving the scope of protection of the invention.

1. (canceled)

2. An inspection vehicle, which is configured for inspecting the interior of an annular cavity, comprising:
a chassis,
two wheel groups which are held on the chassis and which are configured to move the inspection vehicle through the cavity in a circumferential direction, and each of which comprises at least four wheels,
wherein the wheels of the first wheel group are configured to rest on a radially outwardly arranged cavity wall, and
wherein the wheels of the second wheel group are configured to rest on a radially inwardly arranged cavity wall,
several motors which are assigned to the different wheels and drive these by motor in rotation about their respective wheel axles,
a control device actuating the motors, and
an inspection device held on the chassis.

3. The inspection vehicle as claimed in claim 2,
two respective wheels of a wheel group are arranged opposite each other in pairs with respect to the chassis.

4. The inspection vehicle as claimed in claim 2,
wherein none of the wheel axles extends parallel to another wheel axle.

5. The inspection vehicle as claimed in claim 2,
wherein the respective distances between the wheel axles of the wheels of at least one of the wheel groups and the chassis are individually changeable.

6. The inspection vehicle as claimed in claim 2, characterized in that
wherein each motor is connected to a wheel via at least one gear mechanism.

7. The inspection vehicle as claimed in claim 2, further comprising:
at least one supply line for supplying the inspection vehicle with power and/or data and/or compressed air.

8. The inspection vehicle as claimed in claim 7, further comprising:
a winding device for automatically unwinding and winding the at least one supply line.

9. The inspection vehicle as claimed in claim 2,
wherein distance sensors are arranged on the chassis, and are configured and arranged such that they detect actual distances from a side wall of the annular cavity, and
wherein the control device is configured such that it compares the actual distances with nominal distances obtained from CAD data of the cavity, and actuates the motors on the basis of the comparison result.

10. The inspection vehicle as claimed in claim 2,
wherein at least one camera device connected to the control device is held on the chassis and oriented substantially in the axial direction of the annular cavity.

11. The inspection vehicle as claimed in claim 2,
wherein the inspection device comprises a camera device.

12. The inspection vehicle as claimed in claim 2,
wherein the inspection device is held on the chassis so as to be movable by motor relative to the chassis,
pivotable about a first pivot axis extending substantially in the circumferential direction of the annular combustion chamber,
pivotable about a second pivot axis extending parallel to the first pivot axis, and
pivotable about a third pivot axis extending perpendicularly to the second pivot axis.

13. The inspection vehicle as claimed in claim 2,
wherein the annular cavity is in the form of an annular combustion chamber, with an asymmetric cross-section, of a gas turbine of a power station.

14. The inspection vehicle as claimed in claim 5,
wherein the respective distances between the wheel axles of the wheels of at least one of the wheel groups and the chassis are individually changeable and adjustable via pneumatically or electrically operated telescopic devices which are retractable and extendable linearly.

15. The inspection vehicle as claimed in claim 6,
wherein each motor is connected to a wheel via two gear mechanisms, one of which is a worm gear mechanism.

16. The inspection vehicle as claimed in claim 12,
wherein the inspection is movable by motor relative to the chassis linearly along a linear axis extending substantially in the axial direction of the annular combustion chamber.

17. A method for inspecting the interior of an annular cavity, comprising:
inspecting the interior of an annular cavity using an inspection vehicle of claim 2.

18. The method as claimed in claim 17,
wherein the annular cavity is in the form of an annular combustion chamber, with an asymmetric cross-section, of a gas turbine of a power station.
